(19) United States
(12) Patent Application Publication
(10) Pub. No.: US 2021/0272027 A1
(43) Pub. Date: Sep. 2, 2021

(54) SYSTEMS, METHODS AND APPARATUS FOR HIERARCHICAL FORECASTING

(71) Applicant: Kinaxis Inc., Ottawa (CA)

(72) Inventor: Behrouz Haji Soleimani, Halifax (CA)

(21) Appl. No.: 16/805,246

(22) Filed: Feb. 28, 2020

(51) Int. Cl. G06Q 10/04; G06Q 10/06

(52) U.S. Cl. CPC G06Q 10/04; G06Q 10/06315

(57) ABSTRACT

Systems and methods for reconciling a forecast within a hierarchy, comprising a pre-processing module and a forecast reconciliation module. The pre-processing module reconstructs the structure of the hierarchy and captures the relationship between the nodes of the hierarchy in a summation matrix S. The forecast reconciliation matrix uses S, a weight matrix W (that reflects a weighting scheme between the nodes) and a base forecast to optimize the overall forecast error using a least squares procedure. The reconciled forecast has a zero consistency error.

### BACKGROUND

Companies with complex supply chains have a vital interest in predicting their demand for each product a few months in the future. Having an accurate estimate of the demand help companies to plan their manufacturing ahead of time and produce just enough products to avoid overstock and understock. There are inherent hierarchies in the supply chain data that can be used and exploited to arrive at better predictions and forecasting of demand. For instance, products are ordered by different customers and the demand for each product-customer combination can be forecasted separately and aggregated into the total demand of products. Or alternatively the total demand of a product can be forecasted directly from the aggregated historical demands. In any case, there is an aggregation constraint that the sum of demands of a product from different customers should match the total demand of a product. However, if the future demand at different levels of the hierarchy is predicted separately, forecasts will not add up correctly. For this reason, most companies only forecast their demands at the most disaggregated level of a hierarchy (e.g. for each product-customer combination).

Hierarchies can be defined in many different ways and can have many levels. For instance, a hierarchy can be based on geographical regions—such that the total demand of a product equals the sum of demands from different countries and the demand of a given country equals the sum of demands from different regions/districts of that country. Another way a hierarchy can be defined is based on a product family. For instance, the total demand for televisions in an electronics company equals the sum of demand for different sizes or models of televisions. Hierarchies can also be defined based on time dimensions. For example, the sum of weekly demands should match monthly or quarterly demands.

Due to the complicated nature of the problem, most companies predict their demand at only one level of a hierarchy. It is usually the level that a company believes will be most accurate or makes the most sense for the company. Nonetheless, each individual forecast has an associated error. Adding the individual forecasts within the hierarchy leads to a cumulative error in the overall forecast, which can be quite large.

In the realm of time-series forecasting, Hyndman has examined optimally reconciling forecasts in a temporal hierarchies, including optimal forecast reconciliation for hierarchical and grouped time series through trace minimization. However, this study does not readily translate to the management of forecasts of supply chains.

Therefore, there is a need to improve the overall forecasting activity by minimizing the overall forecasting error. In addition, there is a need to provide forecast reconciliation for non-time series hierarchies, such as, for example, supply chains.

### BRIEF SUMMARY

Disclosed herein are systems and methods that can take into account forecasting at different levels of a hierarchy and improve the overall forecasting by reducing the overall forecasting error of the hierarchy. In some embodiments, information about the relationships within the hierarchy is used to take inconsistent forecasts of different levels as input, and reconcile the forecasts to become completely consistent so that they add up correctly. In addition, the overall accuracy of forecasts across the entire hierarchy is improved.

In one aspect, there is provided a computer-implemented method for forecast reconciliation in a hierarchy, the method comprising the steps of: receiving, by a pre-processing module, data related to the hierarchy; generating, by the pre-processing module, the hierarchy based on the data and a summation matrix related to a structure of the hierarchy; receiving, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generating, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

In another aspect, there is provided a computing apparatus for forecast reconciliation in a hierarchy, the computing apparatus comprising: a processor; and a memory storing instructions that, when executed by the processor, configure the apparatus to the steps of: receive, by a pre-processing module, data related to a hierarchy; generate, by the pre-processing module, the hierarchy based on the data and a summation matrix related to a structure of the hierarchy; receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generate, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

In another aspect, there is provided a non-transitory computer-readable storage medium for forecast reconciliation in a hierarchy, the computer-readable storage medium including instructions that when executed by a computer, cause the computer to: receive, by a pre-processing module, data related to a hierarchy; generate, by the pre-processing module, the hierarchy based on the data and a summation matrix related to a structure of the hierarchy; receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generate, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

In another aspect, there is provided a computer-implemented method for reducing a forecast error in a hierarchy, the method comprising the steps of: receiving, by a pre-processing module, data related to the hierarchy; generating, by the pre-processing module, the hierarchy based on the data and a summation matrix related to a structure of the hierarchy; receiving, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generating, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

In another aspect, there is provided a computing apparatus for reducing a forecast error in a hierarchy, the computing apparatus comprising: a processor; and a memory storing instructions that, when executed by the processor, configure the apparatus to the steps of: receive, by a pre-processing module, data related to a hierarchy; generate, by the pre-processing module, the hierarchy based on the data and a summation matrix related to a structure of the hierarchy; receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generate, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

In another aspect, there is provided a non-transitory computer-readable storage medium for reducing a forecast error in a hierarchy, the computer-readable storage medium including instructions that when executed by a computer, cause the computer to: receive, by a pre-processing module, data related to a hierarchy; generate, by the pre-processing module, the hierarchy based on the data and a summation matrix related to a structure of the hierarchy; receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module; generate, by the forecast reconciliation module, a reconciled forecast based on a least squares optimization technique for projecting the base forecast onto a bottom level of the hierarchy, subject to a constraint on each node of the bottom level of the hierarchy.

In some embodiments, the reconciled forecast is based on a non-negative least squares optimization technique. In some embodiments, the reconciled forecast is based on an iterative optimization in which each node of the bottom level forecast is bound within a respective range. In some embodiments, each entry of the weight matrix is related to one or more metrics of the hierarchy; the weight matrix can be diagonal in some instances. In some embodiments, each entry of the weight matrix is related to a forecast error of each node of the hierarchy. In some embodiments; the pre-processing module performs at least one of: i) removing one or more nodes of the hierarchy that have a zero value or a value less than a threshold value; ii) filling one or more missing records of the hierarchy based on sibling information; and iii) extracting rolling features at all levels of the hierarchy.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system architecture in accordance with one embodiment.

FIG. 2 illustrates a block diagram in accordance with one embodiment.

FIG. 3 illustrates an example of a hierarchy in accordance with one embodiment.

FIG. 4 illustrates a hierarchy forecast in accordance with one embodiment.

FIG. 5 illustrates a hierarchy forecast in accordance with one embodiment.

FIG. 6 illustrates a table of symbols.

FIG. 7 illustrates a forecast reconciliation framework in accordance with one embodiment.

FIG. 8 illustrates evaluation of a projection matrix in accordance with one embodiment.

FIG. 9 illustrates evaluation of a projection matrix in accordance with one embodiment.

FIG. 10 illustrates a flow chart in accordance with one embodiment.

FIG. 11 illustrates a flow chart in accordance with one embodiment.

FIG. 12 illustrates a flow chart of a forecast reconciliation in accordance with one embodiment.

FIG. 13 illustrates a comparison of base forecast errors and reconciled forecast errors in accordance with one embodiment.

FIG. 14 illustrates two graphs of demand versus date in accordance with one embodiment.

### DETAILED DESCRIPTION

Disclosed herein are systems and method of hierarchical forecasting that reconcile forecasts and renders all forecasts consistent across an entire hierarchy, thereby solving the inconsistency problem encountered by previous attempts. Furthermore, these systems and methods use information from all levels of the hierarchy to reduce the overall error across the entire hierarchy.

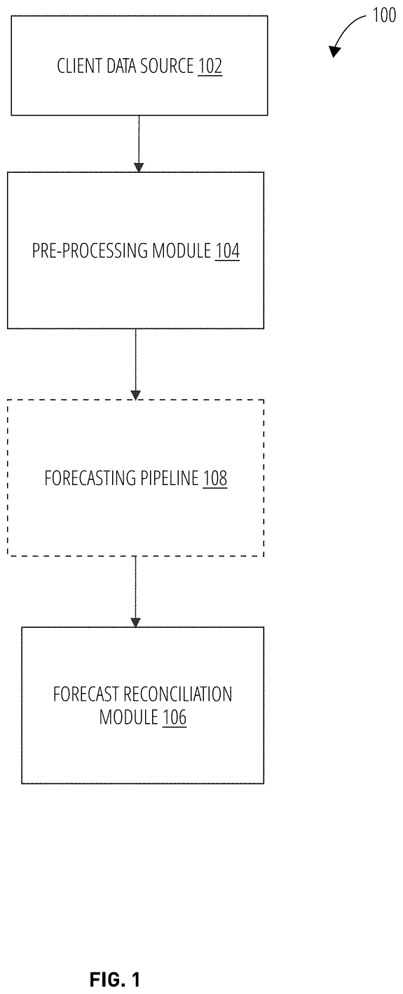

FIG. 1 illustrates a system architecture 100 in accordance with one embodiment.

In some embodiments, the hierarchical forecasting system comprises a pre-processing module 104 and a forecast reconciliation module 106. The two modules can be plugged in to any existing forecasting pipeline 108, thereby making any sets of forecasts consistent and with improved accuracy (by reducing the overall forecasting error). This enables companies to use existing tailored forecasting solutions in conjunction with the hierarchical forecasting system and method disclosed herein.

Client data source 102 provides information about the structure of a hierarchy (from a client), such that the hierarchy can be reconstructed. In some embodiments, the pre-processing module 104 builds the hierarchy and relationships between nodes of the hierarchy, as well as data aggregation for higher levels of the hierarchy.

In some embodiments, the pre-processing module 104 removes nodes that have very small values (i.e less than a threshold value) or have the value zero. Such small quantities add very little value to the forecast reconciliation, yet make the structure more complex.

In some embodiments, the pre-processing module 104 can fill missing records based on sibling information. That is, pre-processing module 104 can exploit the hierarchy to fill in missing information.

In some embodiments, the pre-processing module 104 can extract rolling features (i.e. lag-based features) at all levels of the hierarchy. In some embodiments, such extraction can be accomplished using statistics of the rolling features of children in parents when aggregating data for higher levels.

The forecast reconciliation module 106 ensures that forecasts are consistent and have an overall reduced forecasting error. The forecast reconciliation module 106 comprises an optimization procedure that makes forecasts consistent and more accurate. In some embodiments, the optimization during forecast reconciliation can be constrained. For example, when forecasting a demand in a supply chain, a negative number should not be permitted in the forecast. In some embodiments, both unconstrained and constrained forms of forecast reconciliation can be configured by a user based on the business needs of the company.

In some embodiments, a generic weighting scheme can be used for the optimization. In some embodiments, the weighting scheme can assign an importance value to individual nodes during the optimization based on any business-specific importance values or metrics. In some embodiments, these metrics/values include cost of products, volume of orders, error rate of forecasts, etc. In such cases, the weighting scheme can be devised by the pre-processing module. In some embodiments, the weighting scheme can assign an importance value to the forecast error of each node. In such cases, the weighting scheme is devised following the forecasting pipeline 108, since the forecasting pipeline 108 provides the error estimates for each node in the hierarchy.

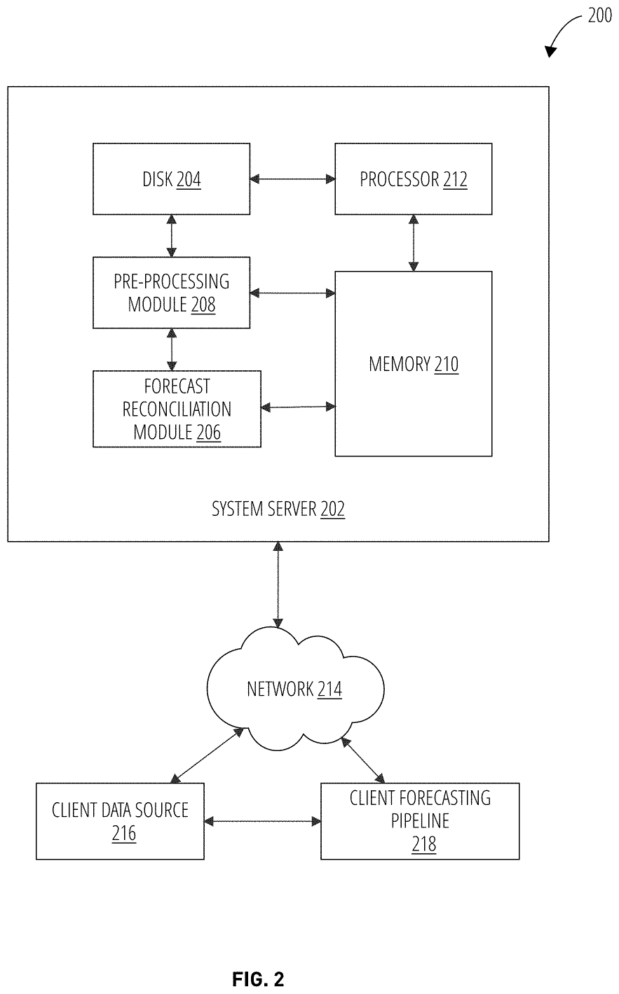

FIG. 2 illustrates a block diagram 200 in accordance with one embodiment of a dynamic demand sensing system.

Block diagram 200 includes a system server system server 202, client data source 216 and client forecasting pipeline 218. System server 202 can include a memory 210, a disk 204, a processor 212, a pre-processing module 208 and a forecast reconciliation module 206. While one processor 212 is shown, the system server 202 can comprise one or more processors. In some embodiments, memory 210 can be volatile memory, compared with disk 204 which can be non-volatile memory. In some embodiments, system server 202 can communicate with client data source 216 and client forecasting pipeline 218 via network 214.

Block diagram 200 can also include additional features and/or functionality. For example, system server 202 can also include additional storage (removable and/or non-removable) including, but not limited to, magnetic or optical disks or tape. Such additional storage is illustrated in FIG. 2 by memory 210 and disk 204. Storage media can include volatile and nonvolatile, removable and non-removable media implemented in any method or technology for storage of information such as computer-readable instructions, data structures, program modules or other data. Memory 210 and disk 204 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system server 202. Any such non-transitory computer-readable storage media can be part of system server 202.

Communication between system server 202, client data source 216 and client forecasting pipeline 218 via network 214 can be over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). Generally, communication between various components of block diagram 200 may take place over hard-wired, cellular, Wi-Fi or Bluetooth networked components or the like. In some embodiments, one or more electronic devices of system 200 may include cloud-based features, such as cloud-based memory storage.

Client data source 216 may provide a variety of raw data from a client. It can comprise enough information to reconstruct a hierarchy—including the structure of the hierarchy and relationships between various nodes of the hierarchy.

Using network 214, system server 202 can retrieve data from client data source 216 and access client forecasting pipeline 218. The retrieved data can be saved in memory 210 or disk 204. In some cases, system server 202 can also comprise a web server, and can format resources into a format suitable to be displayed on a web browser.

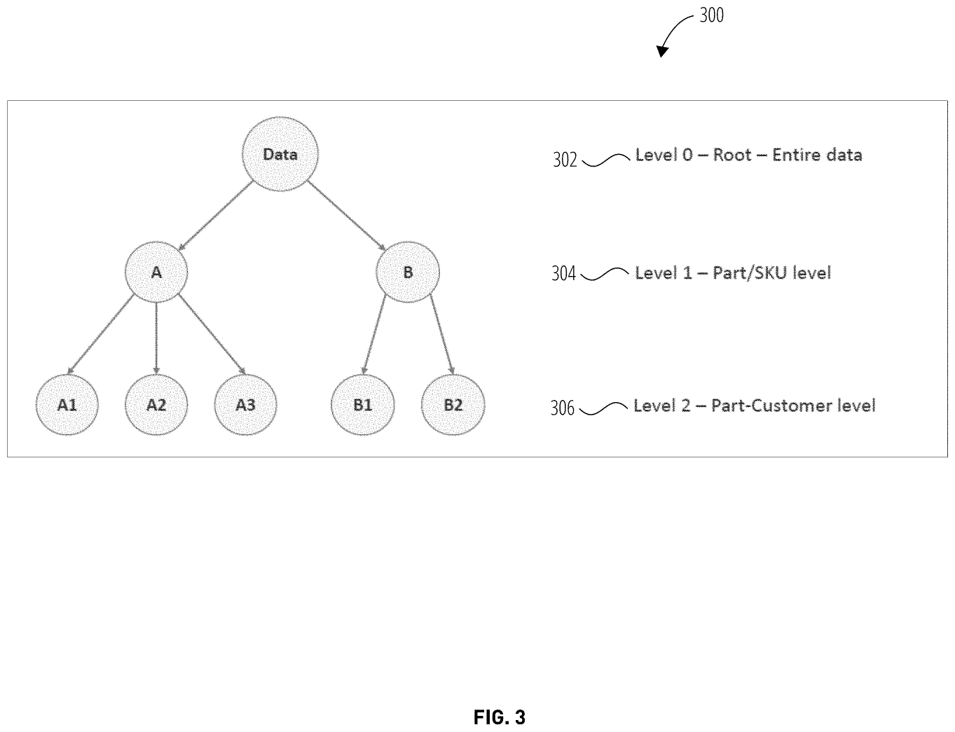

FIG. 3 illustrates an example of a hierarchy 300 in accordance with one embodiment. The example hierarchy 300 is a hierarchy of parts and customers, with three levels: Level 0 302 (the Root or entire data); Level 1 304 (Part/SKU level); and Level 2 306 (Part-Customer level). Eight nodes are labelled as: A1, A2, A3, B1, B2, A, B, Data). There are 5 nodes (A1, A2, A3, B1, B2) at Level 2 306; two nodes (A, B) at Level 1 304 and one node (Data) at Level 0 302. In an embodiment of a supply chain, the hierarchy can have multiple levels and thousands of nodes.

While hierarchy 300 illustrates a customer-parts hierarchy, there can be various forms of a hierarchy.

In a non-limiting example, the hierarchy is a geographical hierarchy, where the different levels of the hierarchy represent different geographical regions. For example, the lowest level can represent major regions of a country; the mid-level can represent different countries; and the top-most level can represent the world total. For example, in a supply chain hierarchy, the sum of the forecast demand from every region (of country A) at nodes A1, A2 and A3 should equal the forecast demand (for country A) at node A. Similarly, the sum of the forecast demand from every region (of country B) at nodes B1 and B2 should equal the forecast demand (for country B) at node B. Finally, the sum of the forecast demand from country A at node A and country B at node B should equal the worldwide forecast demand at Level 0 302 (Data).

In a non-limiting example, the hierarchy is a product hierarchy, where the different levels of the hierarchy represent different types (e.g. Size, make, model) of a product. The sum of the demand for different types/sizes of the product should match the total product demand.

In a non-limiting example, the hierarchy is an event time-based hierarchy, where the different levels of the hierarchy represent different time periods of demand. The sum of weekly demands (Level 2 306) should match monthly/quarterly demands (Level 1 304), which in turn, should match a yearly demand (Level 0 302).

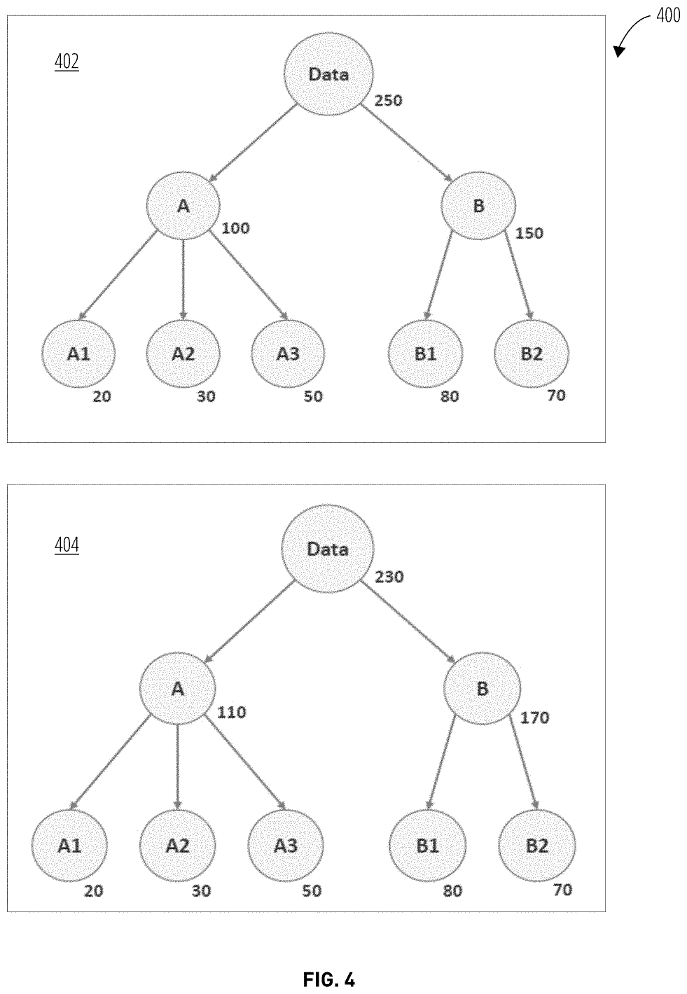

FIG. 4 illustrates a hierarchy forecast 400 in accordance with one embodiment.

An ideal forecast 402 is shown, in which the nodes have the following forecast values: A1=20, A2=30 and A3=50; B1=80 and B2=70; A=100; B=150; and Data=250. Note that in 202, A1+A2+A3=A; B1+B2=B; and A+B=Data. That is, the sum of all of the forecasts for one set of branches at one level equals the forecast for the node above; and the sum of all of the forecasts at one level equals the forecast for the level above.

However, in reality, the forecasts at different levels don't always add up, as forecasts at different levels are made independently of each other. Real forecast 404 illustrates this phenomena. For example, the sum of forecasts for nodes A1, A2 and A3 is: A1+A2+A3=100; whereas the forecast for node A is actually 110. There is a discrepancy of +10, i.e. A—(A1+A2+A3)=10. Similarly, the sum of forecasts for nodes B1 and B2 is: B1+B2=150; whereas the forecast for node B is actually 170. There is a discrepancy of +20, i.e. B—(B1+B2)=20. Furthermore, the sum of the forecast for nodes A and B is: A+B=280; whereas the forecast for Data is 230. There is a discrepancy of −50, i.e. Data−(A+B)=−50.

The discrepancy at each level is called the “consistency error”. This is different from the forecast error, which is the error associated with each forecast (i.e. at each node). For example, A1 has a forecast of 20. While not shown in FIG. 4, this forecast at A1 has an associated uncertainty; for example, A1=20 plus or minus 2. Each node has its own forecasting error, which is provided by an algorithm that formulates each forecast.

In the systems and methods of hierarchical forecasting disclosed herein, the forecasts at each level of the hierarchy are reconciled such that the consistency error is zero. An optimal forecast is obtained at the very bottom level (i.e., the most disaggregated level); these lowest-level optimal forecasts are added in order to calculate the higher-level forecasts, in accordance with a zero consistency error.

Forecast Reconciliation

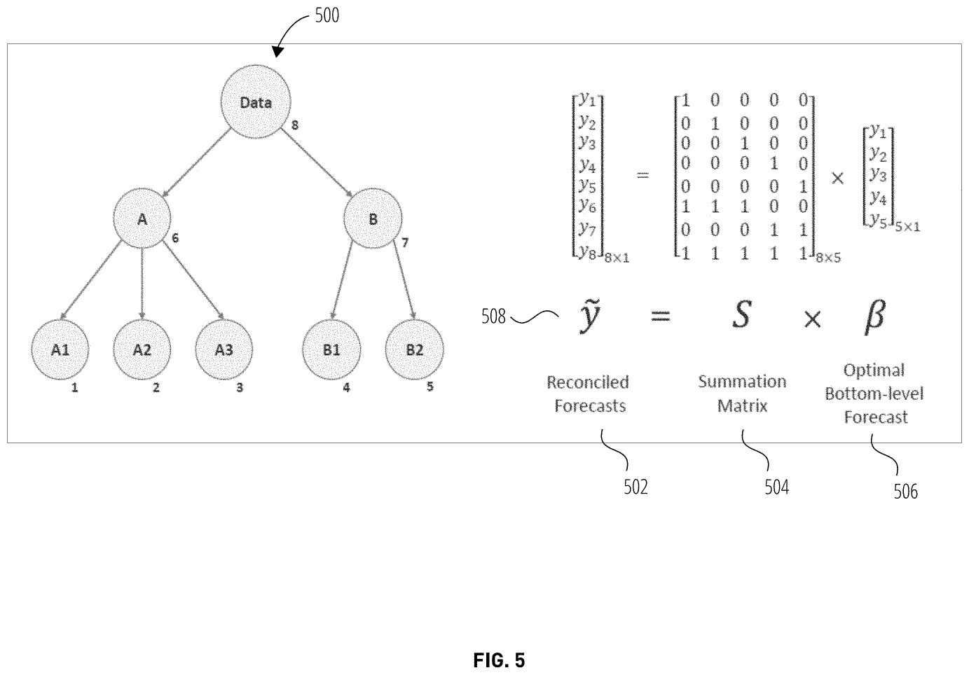

FIG. 5 illustrates a hierarchy forecast in accordance with one embodiment. The example hierarchy 500 has eight nodes (e.g. A1, A2, A3, B 1, B2, A, B, Data) that are indexed from one to eight. Five nodes (A1, A2, A3, B1, B2) are at the lowest level of the hierarchy; two nodes (A, B) are at the mid-level and one node (Data) is at the highest level of the hierarchy. In some embodiments where the hierarchy represents a supply chain, the hierarchy can have multiple levels and thousands of nodes.

Since the consistency error is zero, the reconciled forecasts 502 of each of the eight nodes is the sum of the child forecast nodes below, with the bottom-level nodes having an optimal bottom-level forecast 506. The relationship between the reconciled forecasts 502 and the optimal bottom-level forecast 506 is given by equation 508, in which summation matrix 504 is applied to the optimal bottom-level forecast 506 to yield the reconciled forecasts 502. Summation matrix 504 is an 8×5 matrix for the example shown in hierarchy 500, while optimal bottom-level forecast 506 is a 5×1 vector and the reconciled forecasts 502 is an 8×1 vector. That is:

\tilde{y}=Sβ (1)

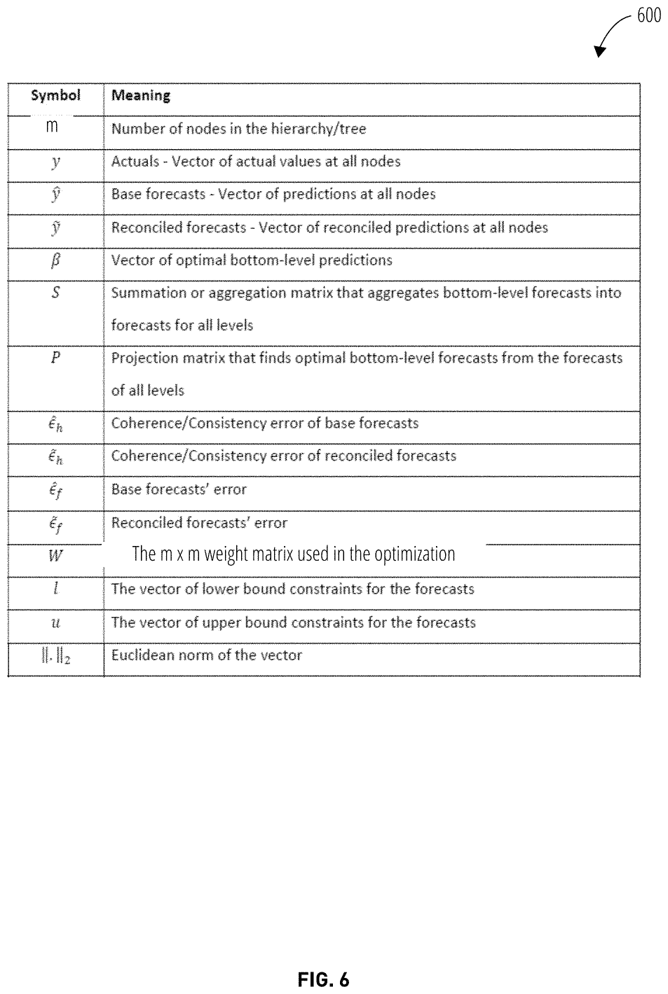

FIG. 6 illustrates a table of symbols 600 that summarizes the various entities used to describe forecast reconciliation in some embodiments.

The problem of finding the reconciled forecasts is now changed to finding the optimal bottom-level forecasts. In some embodiments, the bottom-level forecasts can be estimated by using a projection matrix that maps forecast from all levels to the bottom level. This way, all the forecasts at all levels are used to find the optimal projection to the bottom level:

β=Pŷ (2)

In Eq. (3), y is a vector that represents the base forecasts (i.e. a vector of the forecasts generated by the forecasting pipeline 108 of FIG. 1 at all of the nodes in the hierarchy). Therefore, the problem of finding the optimal bottom-level forecasts is now changed to finding the optimal projection, P, that maps base forecasts optimally to the bottom level of the hierarchy. Once the optimal projection P is obtained, the reconciled forecasts can be computed using the following formula:

\tilde{y}=SPŷ (3)

Using this formulation, the base forecasts are first mapped to the bottom-level using the projection, P, and then the bottom-level forecasts are aggregated to all levels using the summation operation S, defined in FIG. 5. The aggregation operation guarantees 100% consistency across the hierarchy since all the higher level forecasts are computed based on the bottom level.

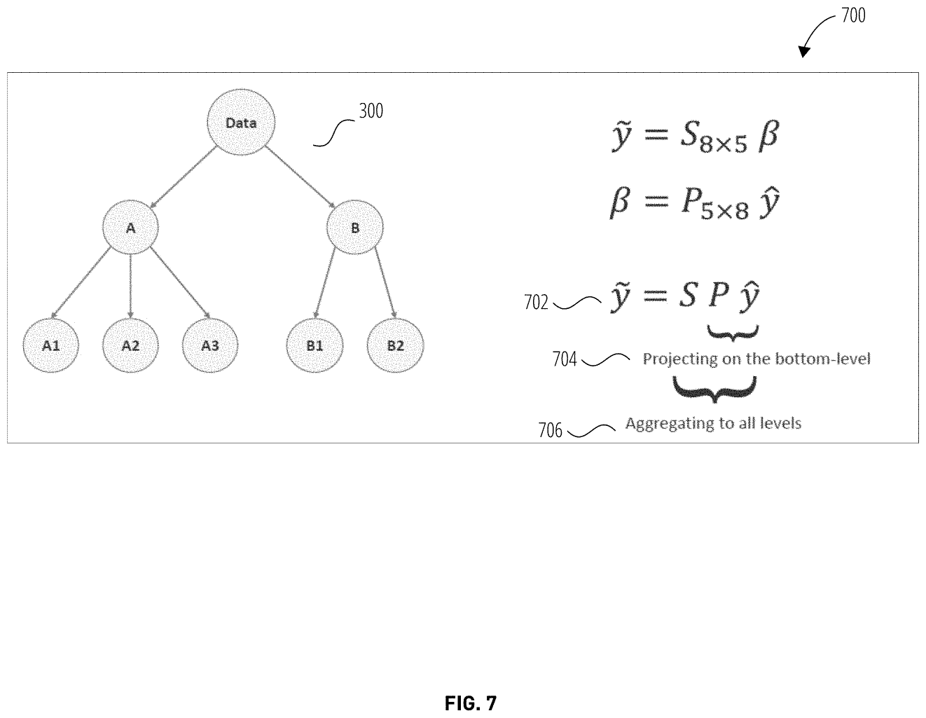

FIG. 7 illustrates a forecast reconciliation framework 700 in accordance with one embodiment, with reference to Eq. (1)-Eq. (3) above. In FIG. 7, equation (3) 702 is broken into two steps: bottom-level projection 704; and aggregation to all levels 706.

In Equation (1), the reconciled forecasts (i.e. the vector of reconciled forecasts at all nodes) is replaced with the base forecasts (i.e. the vector of forecasts at all nodes) and solve the system of linear equations for the vector of optimal bottom-level predictions (β) using an Ordinary Least Squares (OLS) algorithm which results in:

β=(S^{T}S)⁻¹S^{T}ŷ (4)

In Eq. (4), S^{T} is the transpose of summation matrix S. Comparing Equation (2) and (4), the projection matrix P is found as follows:

P=(S^{T}S)⁻¹S^{T} (5)

The projection operation defined in P is a linear transformation. which means every bottom-level forecast in β will be a weighted linear combination of all forecasts. After computing the projection matrix P, any base forecasts can be projected to the bottom level and aggregated back upwards. This enables the algorithm to be used in conjunction with existing forecasting pipelines.

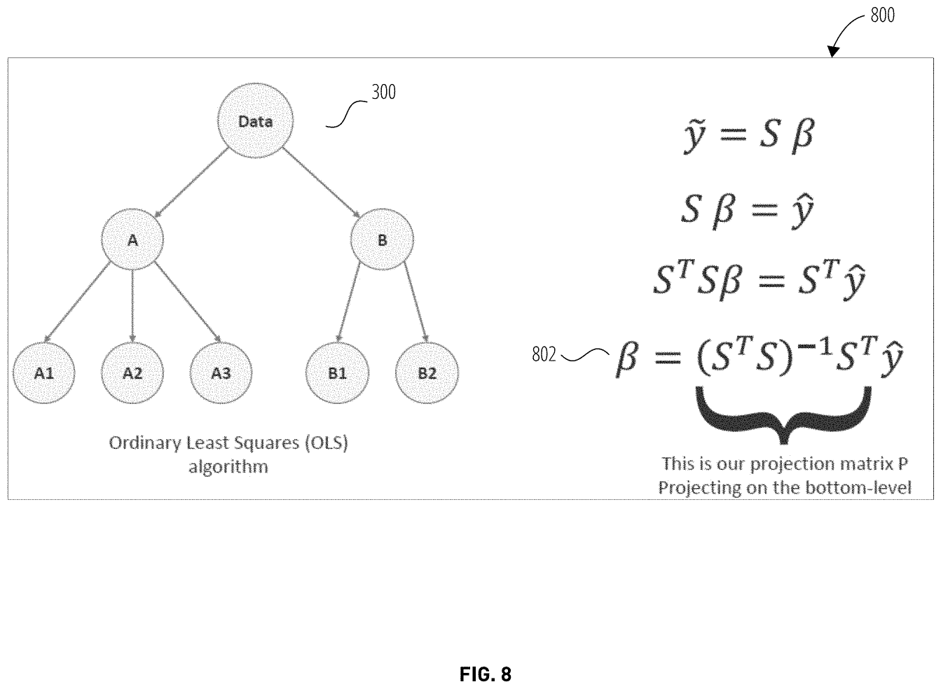

FIG. 8 illustrates evaluation of a projection matrix 800 in accordance with one embodiment, as defined by Eq. (4) and Eq. (5). The bottom-level forecast β is shown in Eq. (4) 802, thereby identifying the projection matrix P.

Generalized Forecast Reconciliation

The OLS solution (see Eq. (5)) can be generalized to a weighted optimization which can consider a weight for each of the nodes of the tree during the optimization. In this generalized form, the projection matrix P can be found using a Generalized Least Squares (GLS) technique:

P=(S^{T}WS)⁻¹S^{T}W (6)

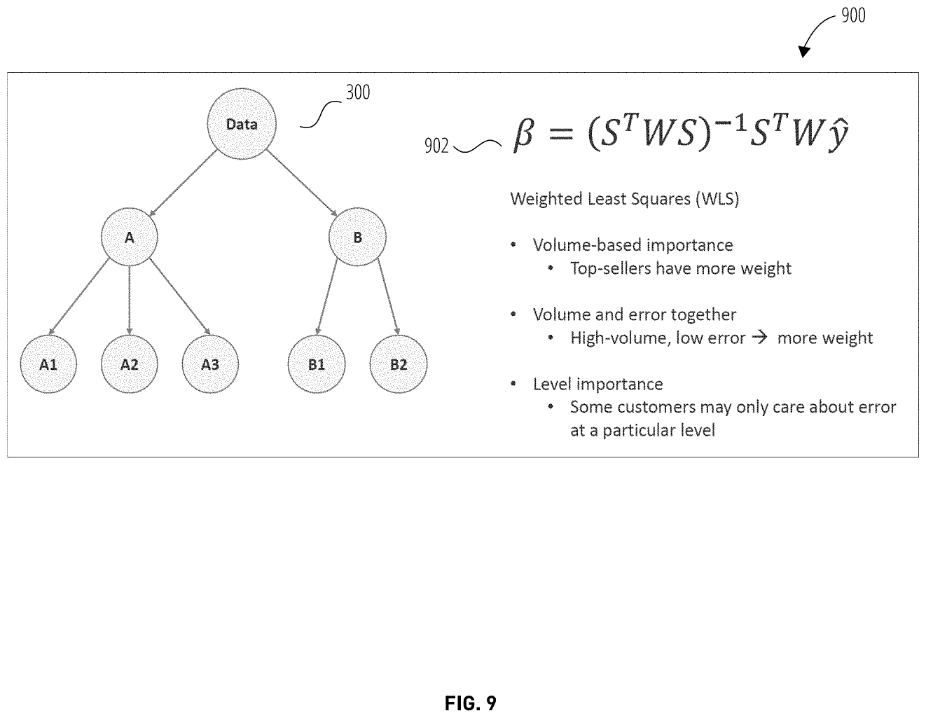

When W is diagonal, the GLS is referred to as Weighted Least Squares (WLS). Eq. (6) is illustrated in FIG. 9, where the equivalent of eq. (6) 902 is shown, along with examples of different embodiments of the weight matrix W. Note that Eq. (6) is general—the weight matrix W can be set to the identity matrix when no particular weighting scheme is used.

The hierarchy is built once and is defined by summation matrix S. In the example hierarchy 300, the weight matrix W is an 8×8 matrix. In some embodiments, W is a diagonal matrix (i.e. all the off-diagonal elements are 0 and only the diagonal elements—8 elements corresponding to 8 nodes—are non-zero). Examples can be inverse of error rate of base forecasts, volume of orders in each node, total cost/value of orders in each node, etc. The off-diagonal elements weight the relationship between nodes.

In some embodiments, the inverse of error rate of the base forecasts is used as diagonal entries of the weight matrix W. In such embodiments, the projection to the bottom level of the hierarchy is a Best Linear Unbiased Estimate (BLUE).

This weighting scheme can be extended to allow a customer to use any business-specific importance value or metric desired by the customer. In some embodiments, importance can be assigned to a node based on the volume of orders in that node. In some embodiments, importance can be assigned to a node based on the total cost of items in the node. In some embodiments, importance can be assigned to different levels of the hierarchy. As can be seen, importance can be assigned to any other metric.

These weights determine the importance of each item in the optimization when finding the projection. For example, if a first product is ordered ten times a second product, then the first product has more impact on the forecast reconciliation. In some embodiments, a combination of error rate and volume/cost is used, such that a top-selling product with low error rate has the greatest impact on the reconciliation.

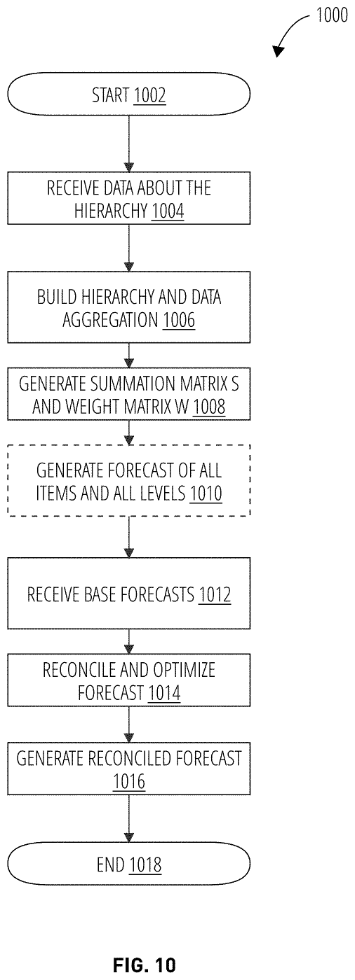

FIG. 10 illustrates a flow chart 1000 in accordance with one embodiment of hierarchical forecasting. At step 1004, the pre-processing module 104 (of FIG. 1) receives data that permits the construction of a hierarchy. For example, pre-processing module can receive records or tabular data with a set of key columns that correspond to hierarchy levels. At step 1006, the pre-processing module 104 builds the hierarchy and data aggregation and generates a summation matrix S related to the hierarchy at step 1008. In the embodiment shown in FIG. 10, the weight matrix W is also generated at step 1008. Here, the weight matrix W is related to the metrics of each node in the hierarchy. This information is then plugged into the existing forecasting pipeline 108 (of FIG. 1) that, at step 1010, generates a forecast of all items and all levels (i.e. a base forecast). At step 1012, the forecast reconciliation module 106 (of FIG. 1) receives the base forecasts, and at step 1014, reconciles and optimizes the forecast to generate a reconciled forecast at step 1016.

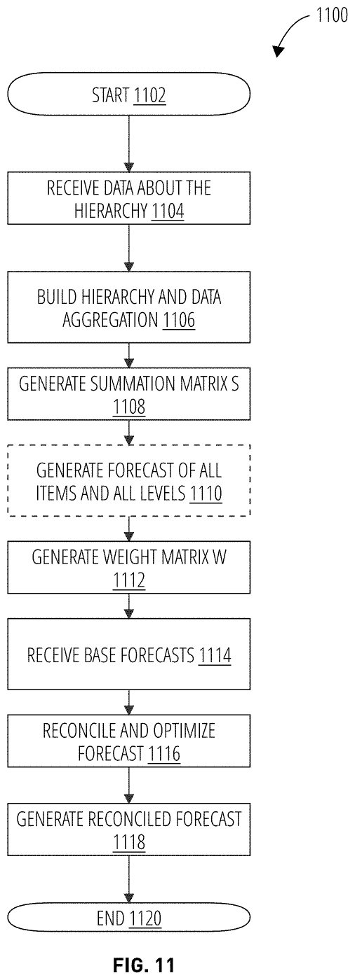

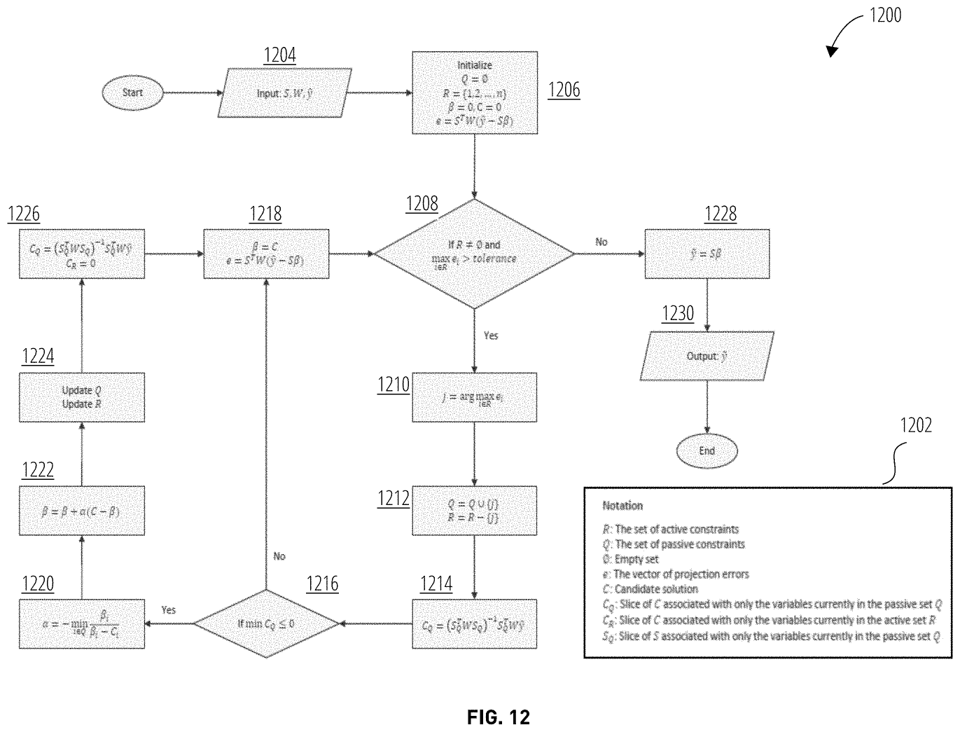

FIG. 11 illustrates a flow chart 1100 in accordance with one embodiment of hierarchical forecasting. At step 1104, the pre-processing module 104 (of FIG. 1) receives data that permits the construction of a hierarchy. For example, pre-processing module can receive records or tabular data with a set of key columns that correspond to hierarchy levels. At step 1106, the pre-processing module 104 builds the hierarchy and data aggregation and generates a summation matrix S related to the hierarchy at step 1108. This information is then plugged into the existing forecasting pipeline 108 (of FIG. 1) that, at step 1110, generates a forecast of all items and all levels (i.e. a base forecast). In the embodiment shown in FIG. 12, the weight matrix W is generated at step 1112. Here, W is related to the forecasting errors at each node, each of which is generated during step 1110. At step 1114, the forecast reconciliation module 106 (of FIG. 1) receives the base forecasts, and at step 1116, reconciles and optimizes the forecast to generate a reconciled forecast at step 1118.

Constrained Forecast Reconciliation

As described above, the generalized least squares (GLS) optimization adjusts forecasts such that the overall forecast error is reduced and ensures that the reconciled forecasts add-up correctly (that is, the consistency error is zero). However, this results in some of the forecasts having a negative value. Yet there exist domain-specific constraints in different applications. For example, if demand of products is being forecasted, the reconciled forecasted demand cannot be negative. However, integration of such a constraint is not trivial or known to the optimization algorithm. In order to solve this non-trivial problem, non-negativity constraints are imposed during the optimization. In this modified approach, a Non-Negative Least Squares (NNLS) algorithm is used to find the bottom-level reconciled forecasts β, given the constraints that they cannot be negative:

$$β = arg {min}_{β} {‖ S β - \hat{y} ‖}_{2} subject to β > 0 \qquad ( 7 )$$

This form of optimization differs from the weighted least squares technique in that it does not have a closed-form solution. The OLS and WLS both have closed form solutions which can be obtained directly by solving the equations (5) and (6), respectively. However, the constrained form of optimization requires iterative optimization and numerical solvers.

The NNLS in Equation (7) may be solved using an active set method in which the set of constraints that are active are maintained at any candidate solution. A constraint is called active if the candidate solution lies exactly on the boundary which means slight alterations in the solution may violate those constraints. The active set determines which constraints influence the final result of optimization. The solution found by the constrained optimization may not be the optimal answer in terms of having the minimum overall error, however, it guarantees that the solution satisfies all the constraints, and therefore, it is optimal in the feasible region of search space.

In some embodiments, any arbitrary form of inequality constraint for any node in the tree can be used. For instance, if a predicted quantity is constrained to be between a lower bound and an upper bound, a Bounded-Variable Least Squares (BVLS) optimization can be used:

$$β = arg {min}_{β} {‖ S β - \hat{y} ‖}_{2} subject to l < β < u \qquad ( 8 )$$

In some embodiments, each node in the hierarchy can have its own lower and upper bound constraint. Bounded-Variable Least Squares (BVLS) method is also an iterative optimization that requires numerical solvers. Similar to NNLS, BVLS also uses an active set strategy with the difference that it maintains two sets of active constraint: one for active lower bound constraints and another for active upper bound constraints. This way, at each iteration of the optimization, it is known which constraints are likely to be violated and therefore, the optimization can be guided accordingly.

This type of constrained optimization with arbitrary constraints is useful for many application in supply chain. For instance, if a company knows that the actual delivery of a product cannot be higher than a number based on their production capacity or manufacturing constraints, this information can be incorporated in the optimization by setting the upper bound on the predicted values.

In some embodiments, the NNLS optimization can also be solved using the BVLS by setting the lower bound to zero and the upper bound to infinity. However, since the BVLS is computationally slightly slower than NNLS due to maintaining and checking for two sets of constraints at every iteration, the non-negative constrained variant is solved using the NNLS optimization. In fact, the developed solutions of hierarchical forecasting determine the right optimization technique based on the user configuration, so that the user does not require to have any knowledge about the underlying mechanism and optimization.

In summary, methods and systems of hierarchical forecasting disclosed herein eliminate the consistency error completely, while guaranteeing a reduction in the overall forecast error.

FIG. 12 illustrates a flow chart 1200 of a forecast reconciliation in accordance with one embodiment. The notation 1202 of some of the symbols in the flow chart is provided.

At step 1204, summation matrix S, weight matrix W, and base forecast y HAT are input. Summation matrix S is constructed from the hierarchy. Weight matrix W is constructed based on customer preference; it can be constructed prior to the forecasting pipeline. Alternatively, if W includes the base forecasting errors, it is constructed after the forecasting pipeline, since the forecasting pipeline generates the base forecasting errors.

Summation matrix S is an m×n matrix; weight matrix W is an m×m matrix, and y hat is an m×1 vector, where ‘m’ denotes the total number of nodes in the hierarchy and ‘n’ denotes the total number of nodes in the lowest level of the hierarchy.

At step 1206, initialization of the iteration takes place. Initially, the set of passive constraints Q, an n×1 vector, is set to empty; the candidate solution C is set to zero, as are the reconciled forecasts β (which is an n×1 vector). The set of active constraints R, an n×1 vector, is defined for the ‘n’ lowest nodes in the hierarchy. The error vector ‘e’ is an n×1 vector. components denote the projection error at each of the lowest nodes in the hierarchy. Initially, e=S^{T}W y hat.

From step 1208 to step 1214, the set of active and passive constraints are computed; at decision 1216, a portion of the solution is tested for negativity. If there is no negativity, then a new iterated error vector e and reconciled forecasts vector β are computed at step 1218. At step 1208, the dual condition of a non-null set of active constraints R, and the maximum error for nodes associated with R are tested. If the test condition in 1008 is not satisfied, then the iterative process ends, with reconciled forecast computed at step 1228. If both conditions, shown in step 1208, are satisfied, then the step 1210 to decision 1216 is repeated.

At decision 1216, if there is negativity in a portion of the candidate solution C_{Q}, step 1220 and step 1222 are performed to remove the negativity; the set of passive constraints Q and the set of active constraints R are updated at step 1224. The candidate solution C is computed, followed by computation of a new iterated error vector e and reconciled forecasts vector β are computed at step 1218. If the test condition at step 1208 is not satisfied, then the iterative process ends, with reconciled forecast computed at step 1228. If both conditions, shown in step 1208, are satisfied, then the step 1210 to decision 1216 is repeated.

The iterative procedure is repeated until the condition set at step 1208 is not satisfied; the reconciled forecast is then computed at step 1228, providing the output at step 1230.

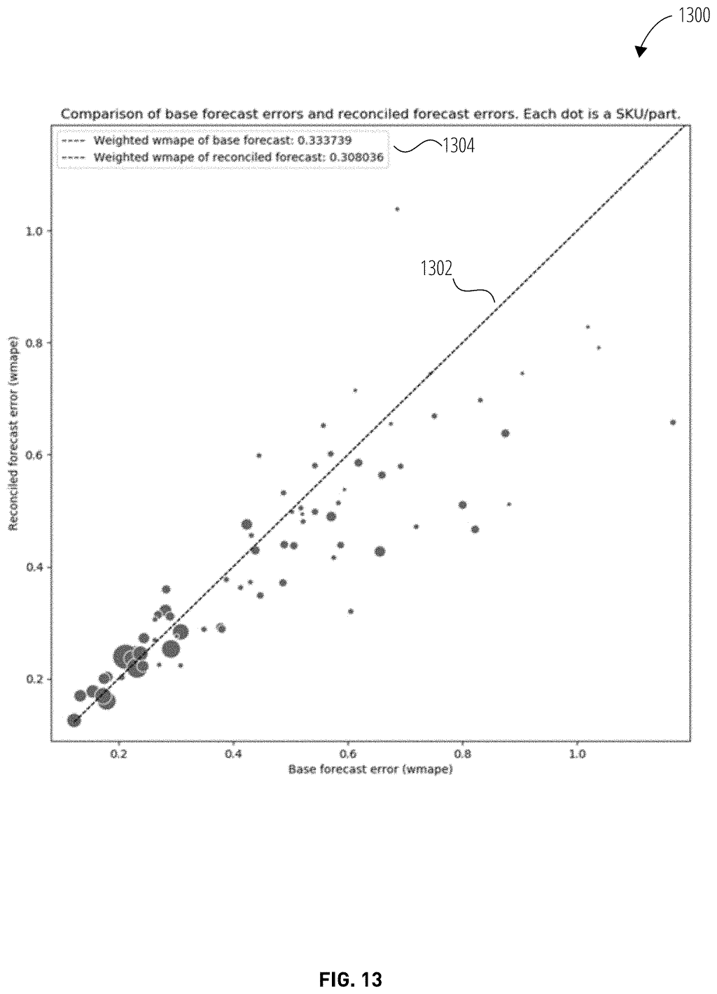

FIG. 13 illustrates a comparison 1300 in accordance with one embodiment, in which reconciled forecast errors are plotted against base forecast errors for different parts/SKUs. This plot and the forecasts are based on real customer data comprising 80 different parts and more than 800 part-customers. Each circle in the plot correspond to a node in the middle level of the hierarchy (i.e. part). The size of each circle is proportionate to the volume of orders in the corresponding node.

Line 1302, with a slope of 1, demarcates where the reconciled forecast error has improved over the base forecast error. The hierarchical forecast reconciliation has improved the forecast accuracy (i.e. reduced the error) for the circles below line 1302 and has decreased the accuracy (i.e. increased the error) for the circles above line 1302. From the graph shown in FIG. 13, the hierarchical reconciliation has improved the majority of forecasts in the hierarchy as most of the circles are below line 1302. This is reflected in item 1304, which shows that the overall forecast error has been reduced from 0.3333739 to 0.308036, which is equivalent to a 7.6% improvement. The forecast error is calculated using Weighted Mean Absolute Percentage Error (WMAPE).

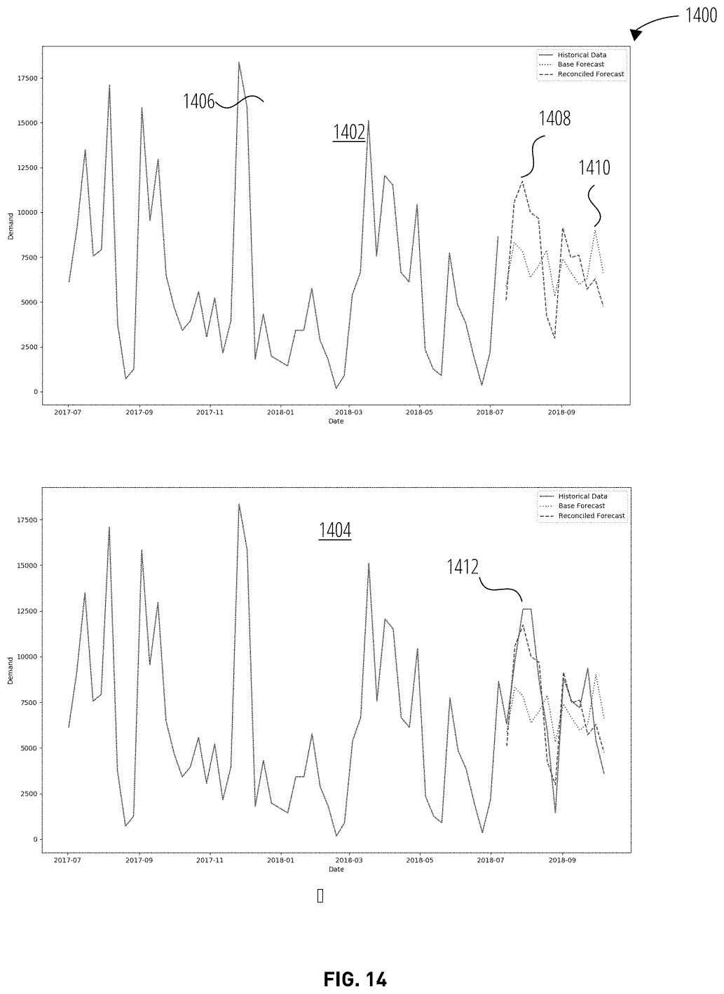

FIG. 14 illustrates two graphs 1400 of demand versus date in accordance with one embodiment.

In graph 1402, historical demand 1406 is shown from July 2017 to July 2018. A pipeline forecasting program (e.g. forecasting pipeline 108 in FIG. 1) is used to provide a base forecast 1408 of the demand from July 2018 onward. A reconciled forecast 1410 is shown from July 2018 onward.

In graph 1404, the actual demand 1412 from July 2018 onward is shown relative to the reconciled forecast 1410 and the base forecast 1408. As evident from 1204, the reconciled forecast 1410 is a marked improvement of the predicted demand (from July 2018 onward) than the base forecast 1408 of the demand.

Although the algorithms described above including those with reference to the foregoing flow charts have been described separately, it should be understood that any two or more of the algorithms disclosed herein can be combined in any combination. Any of the methods, modules, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner and can be used separately or in combination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method for forecast reconciliation in a hierarchy, the method comprising the steps of:
receiving, by a pre-processing module, data related to the hierarchy;
generating, by the pre-processing module, the hierarchy based on the data and a summation matrix related to a structure of the hierarchy;
receiving, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module;
generating, by the forecast reconciliation module, a reconciled forecast based on a least squares optimization technique for projecting the base forecast onto a bottom level of the hierarchy, subject to a constraint on each node of the bottom level of the hierarchy.

2. The computer-implemented method of claim 1, wherein the reconciled forecast is based on a non-negative least squares optimization technique.

3. The computer-implemented method of claim 1, wherein the reconciled forecast is based on an iterative optimization in which each node of the bottom level forecast is bound within a respective range.

4. The computer-implemented method of claim 1, wherein each entry of the weight matrix is related to one or more metrics of the hierarchy.

5. The computer-implemented method of claim 4, wherein the weight matrix is diagonal.

6. The computer-implemented method of claim 1, wherein each entry of the weight matrix is related to a forecast error of each node of the hierarchy.

7. The computer-implemented method of claim 1, wherein the pre-processing module performs at least one of:
i) removing one or more nodes of the hierarchy that have a zero value or a value less than a threshold value;
ii) filling one or more missing records of the hierarchy based on sibling information; and
iii) extracting rolling features at all levels of the hierarchy.

8. A computing apparatus, the computing apparatus comprising:
a processor; and
a memory storing instructions that, when executed by the processor, configure the apparatus to the steps of:
receive, by a pre-processing module, data related to a hierarchy;
generate, by the pre-processing module, the hierarchy based on the data and a summation matrix related to a structure of the hierarchy;
receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module;
generate, by the forecast reconciliation module, a reconciled forecast based on a least squares optimization technique for projecting the base forecast onto a bottom level of the hierarchy, subject to a constraint on each node of the bottom level of the hierarchy.

9. The computing apparatus of claim 8, wherein the reconciled forecast is based on a non-negative least squares optimization technique.

10. The computing apparatus of claim 8, wherein the reconciled forecast is based on an iterative optimization in which each node of the bottom level forecast is bound within a respective range.

11. The computing apparatus of claim 8, wherein each entry of the weight matrix is related to one or more metrics of the hierarchy.

12. The computing apparatus of claim 11, wherein the weight matrix is diagonal.

13. The computing apparatus of claim 8, wherein each entry of the weight matrix is related to a forecast error of each node of the hierarchy.

14. The computing apparatus of claim 8, wherein the pre-processing module performs at least one of:
i) remove one or more nodes of the hierarchy that have a zero value or a value less than a threshold value;
ii) fill one or more missing records of the hierarchy based on sibling information; and
iii) extract rolling features at all levels of the hierarchy.

15. A non-transitory computer-readable storage medium, the computer-readable storage medium including instructions that when executed by a computer, cause the computer to:
receive, by a pre-processing module, data related to a hierarchy;
generate, by the pre-processing module, the hierarchy based on the data and a summation matrix related to a structure of the hierarchy;
receive, by a forecast reconciliation module, a base forecast of the hierarchy, the summation matrix and a weight matrix, the weight matrix reflecting a weighting scheme for each node of the hierarchy, the weight matrix generated by either the pre-processing module or the forecast reconciliation module;
generate, by the forecast reconciliation module, a reconciled forecast based on a least squares optimization technique for projecting the base forecast onto a bottom level of the hierarchy, subject to a constraint on each node of the bottom level of the hierarchy.

16. The computer-readable storage medium of claim 15, wherein the reconciled forecast is based on a non-negative least squares optimization technique.

17. The computer-readable storage medium of claim 15, wherein the reconciled forecast is based on an iterative optimization in which each node of the bottom level forecast is bound within a respective range.

18. The computer-readable storage medium of claim 15, wherein each entry of the weight matrix is related to one or more metrics of the hierarchy.

19. The computer-readable storage medium of claim 18, wherein the weight matrix is diagonal.

20. The computer-readable storage medium of claim 15, wherein each entry of the weight matrix is related to a forecast error of each node of the hierarchy.
